(19) United States
(12) Patent Application Publication
(10) Pub. No.: US 2025/0174078 A1
(43) Pub. Date: May 29, 2025

(54) INTEGRATION OF NETWORK-CONNECTED WAGERING GAMES WITH REAL WORLD TABLE GAMES

(71) Applicant: IGT, Las Vegas, NV (US)

(72) Inventors: Aaron COREY, Moncton (CA); Jackie ALVAREZ, Las Vegas, NV (US); Gaurav JARIWALA, Halifax (CA); Daniel LANDRY, Moncton (CA); Anthony BAERLOCHER, Henderson, NV (US); David FROY, Lakeville-Westmorland (CA); Carman MISENER, Moncton (CA); Michael RUSS, Graz (AT)

(73) Assignee: IGT, Las Vegas, NV (US)

(21) Appl. No.: 18/522,160

(22) Filed: Nov. 28, 2023

(51) Int. Cl. G07F 17/32

(52) U.S. Cl. CPC G07F 17/3225; G07F 17/322; G07F 17/3267; G07F 17/3288

(57) ABSTRACT

A first wager from a first player for a first wagering game at physical table game in a casino environment is determined, the physical table game including a physical game object. A second wager is determined from a second player for a second wagering game different from the first wagering game via a computing device associated with the second player. A sensor device at the physical table game detects a parameter value associated with physical game object. A first game result for the first wagering game is determined, and based on the detected parameter value, a second game result for the second wagering game is determined. In response to the second game result being a winning game result, a game award is provided to the second player.

### BACKGROUND

Embodiments described herein relate to network-connected wagering games, and in particular to integration of network-connected wagering games with real world table games in a casino environment, and related devices, systems, and methods. Table games in casinos may provide wagering opportunities for players at the tables for primary wagering games as well as side bets, side bets, or other secondary games. One drawback of physical table games is that the tables may only accommodate a limited number of in-person players. There is a need for a unique technical solution to the technical problem of providing back betting and other types of secondary game opportunities on physical table games to a larger pool of players.

### BRIEF SUMMARY

According to some embodiments, a system includes a processor circuit and a memory coupled to the processor circuit. The memory includes machine-readable instructions that, when executed by the processor circuit, cause the processor circuit to determine a first wager from a first player for a first wagering game at physical table game in a first casino environment, the physical table game comprising a physical game object. The instructions further cause the processor circuit to determine a second wager from a second player for a second wagering game different from the first wagering game via a computing device associated with the second player. The instructions further cause the processor circuit to detect, by a sensor device at the physical table game, a parameter value associated with physical game object. The instructions further cause the processor circuit to determine a first game result for the first wagering game. The instructions further cause the processor circuit to, based on the detected parameter value, determine a second game result for the second wagering game. The instructions further cause the processor circuit to, in response to the second game result being a winning game result, provide a game award to the second player.

According to some embodiments, a gaming device includes a table game play area, a sensor device, a processor circuit, and a memory coupled to the processor circuit. The memory comprising machine-readable instructions that, when executed by the processor circuit, cause the processor circuit to determine a first wager from a first player for a first wagering game at the gaming device in a first casino environment, the first wagering game comprising a physical game object. The instructions further cause the processor circuit to determine a second wager from a second player for a second wagering game different from the first wagering game via a computing device associated with the second player. The instructions further cause the processor circuit to detect, by the sensor device, a parameter value associated with physical game object. The instructions further cause the processor circuit to determine a first game result for the first wagering game. The instructions further cause the processor circuit to, based on the detected parameter value, determine a second game result for the second wagering game. The instructions further cause the processor circuit to, in response to the second game result being a winning game result, provide a game award to the second player.

According to some embodiments, a method includes determining, by a processor circuit, a first wager from a first player for a first wagering game at physical table game in a first casino environment, the physical table game comprising a physical game object. The method further includes determining, by the processor circuit, a second wager from a second player for a second wagering game different from the first wagering game via a computing device associated with the second player. The method further includes detecting, by a sensor device at the physical table game, a parameter value associated with physical game object. The method further includes determining, by the processor circuit, a first game result for the first wagering game. The method further includes, based on the detected parameter value, determining, by the processor circuit, a second game result for the second wagering game. The method further includes, in response to the second game result being a winning game result, providing a game award to the second player.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIGS. 3A-3C illustrate a table game system integrating a real world card game table with a network-connected mobile device and/or electronic table game device, according to some embodiments.

FIGS. 4A and 4B illustrate a table game system integrating a real world roulette table and a network-connected mobile device, according to some embodiments.

FIG. 5 is a flowchart illustrating operations of systems/methods of integrating a real world roulette table and a network-connected mobile device, according to some embodiments.

### DETAILED DESCRIPTION

Embodiments described herein relate to network-connected wagering games, and in particular to integration of network-connected wagering games with real world table games in a casino environment, and related devices, systems, and methods. Embodiments may include a system for remote wagering in a secondary game by a pool of players on one or more primary games, e.g., physical table games, in a casino. Secondary games, such as back bets, may include separate games whose outcomes are derived from the primary game, and/or games where players bet on specific events or outcomes in the primary game, as desired. In some examples, the primary games are live games, i.e., the primary games are taking place concurrently with the secondary game, and/or pre-recorded games, i.e., the primary games are historical games that took place at an earlier time and had their significant events and/or outcomes recorded for later use by the secondary game. The players of the secondary game may be a separate group of players from the players of the primary game, and may be located in a casino, i.e., on site, and/or virtually, i.e., online, as desired.

The primary game may be a physical table game such as a card game (e.g., poker, blackjack, baccarat), roulette, craps, etc. Events and outcomes in these types of games may be captured in a digital format by sensor devices for use in remote secondary games and/or other electronic games, such as Electronic Table Games (ETGs). Sensors may include image capture devices, scanners, and/or other detection devices, and may be integrated into the physical table and/or other hardware, such as a card shuffler, a card shoe, a roulette wheel, dice, etc. For example, a card shoe may include an integrated image recognition scanner to track, in real-time, every card that is coming out of the shoe.

These and other embodiments provide a unique technical solution to the technical problem of enabling back betting on physical table games by a larger number of players. In this manner, participation and engagement with in casino table games may be without affecting the odds or gameplay in the original primary game. In some examples, other players may back bet on the primary game in a secondary game, e.g., via EGMs, ETGs on the casino floor (or another casino floor), or online via a mobile computing device or other computing device. Because this secondary betting is separate from the wagering in the original primary game, any number of players can participate in the secondary game without influencing the odds, outcome, or gameplay in the primary game.

In some examples, additional interactive features can increase player engagement, such as a side game on an EGM and/or ETG that is based in part on the gameplay of the primary game and that can be played alongside another EGM and/or ETG game as an added source of entertainment. For example, these and other features may provide additional wagering opportunities during a lull in activity as an ETG game and may keep the player engaged for longer play sessions.

In some examples, secondary game players can wager on the table game events or outcomes directly, or may wager on other games that are derived from table game events, such as an EGM slot game that mathematically derives its outcomes from the table game outcomes instead of an electronic Random Number Generator (RNG). For example, the primary game data (e.g., events and outcomes) used for the secondary game can be obtained from a live game that is occurring concurrently with the secondary game and/or a historical game that occurred prior to the secondary game. Because the primary game data is being captured and stored digitally, the game data can be used in real time and/or used or re-used at a later time, as desired.

For example, a machine vision system for roulette may analyze still or video images of the roulette wheel and determine the location of the ball on the roulette wheel. Sensors in the wheel and/or ball may detect the final resting position of the roulette ball. In some examples, light reflected from the ball can be detected by an optical sensor or camera positioned above the wheel, with a modulated light source built into the roulette wheel such that it reflects off the ball and is detected by the sensor or camera. In some examples, optical sensors can be placed below the roulette wheel surface with a small hole above each one, such that the ball blocks light from entering one of the holes, allowing the position of the ball to be detected.

In some examples, display space at an EGM can be used for secondary games, including game information and/or video footage that is streamed to the EGM through its network connection, such that the game footage is visible to the player at the same time as another game, e.g., a primary slot game at the EGM. The secondary game can be based on a table game that is occurring elsewhere in the same or different casino at the same time, and/or that occurred at an earlier time and was recorded in the same or different casino, as desired.

In some examples, ETGs may incorporate elements of physical table games such as physical cards or physical roulette wheels, which may employ hardware such as a card shuffler, card shoe or roulette wheel that contain embedded sensor technologies that capture digital data about physical events occurring in the game. For example, a card shoe may contain an optical scanner that identifies each card as it is dealt from the card shoe and conveyed to the computer that controls the ETG product. Similarly, a roulette wheel may contain sensors that detect the pocket in the wheel where the ball lands during each spin. The information about the pocket where the ball lands is conveyed to the computer that controls the ETG product. The data captured by these electronic sensors can then be incorporated into the electronic gaming functionality of the ETG product. In this manner, the data captured by the electronic sensors can also be used for additional purposes outside of the ETG, such as incorporating it into a remote secondary wagering game at another device, such as an EGM or mobile device, for example.

In some examples, an overhead video camera can be used to capture video footage of a live table game, e.g., a live card game roulette, craps, in a casino, which may be streamed live for use in a secondary game being played concurrently with the primary game, and/or recorded for use in a secondary game being played at a later time than the primary game.

In some examples, a secondary game may be based on randomly selected cards in a card shuffler (physical cards or digital cards). For example, a randomly selected mystery prize may be associated with a random playing card by a computer system. A card shuffler scans actual playing cards while they are being shuffled. If the card scanned by the shuffler matches the card that's associated with the mystery prize in the computer system, the prize may be awarded to the player, who may be playing in a casino or playing online/virtually. In some embodiments, a progressive game may be provided, where a percentage of the wagers are accumulated as a mystery jackpot prize for the winning player.

In some examples, a card scanner may scan all cards being brought into the game, and the system may calculate the chances of each remaining card, card property (e.g., color, suit, etc.) and/or game event (e.g., flush, straight, etc.) to be dealt next.

In some examples, scanned cards from the card shuffler may be used as the source of random outcomes for a secondary game. In some examples, multiple shufflers across multiple casino properties may be used in tandem to ensure a sufficiently large pool of outcomes. The values of the scanned playing cards may be correlated to outcomes (i.e., reel stops) in a video reel game or a mechanical stepper games, and/or to determine cards dealt and/or outcomes in a video poker game, for example. In some examples, a secondary game may be based on selecting the next table on a casino floor to deal a particular card, with all shufflers and/or shoes connected to the system. In some examples, a secondary game may be based on the next table to deal a particular card generating a particular primary game result.

In some examples, a mystery prize can be associated with a random number on a roulette wheel, such that a roulette game outcome matching the number associated with the mystery prize results in a winning secondary game outcome. In some examples, roulette outcomes may be used as a source of random outcomes for an EGM game, with roulette outcomes correlated to EGM outcomes (e.g., reel stops) in a video reel game or a mechanical stepper game.

In some examples, a secondary game may be based on cards dealt in primary game, such as a physical blackjack primary game where the secondary game allows other players to wager on the timing of particular cards, combinations of cards, hands, etc., being dealt in the primary game. For example, players in the secondary game may wager on when particular cards (e.g., aces) will be dealt in the primary game. The wagers may be placed prior to a new deck being put into play in the primary game.

In some examples, the primary game may be video streamed so that other players in different areas of the casino and online/remote player in other locations can see the game and engage in secondary wagering games (i.e., back betting), which functionality may be integrated into the streaming service. Live streaming of actual live games such as high-level poker or sports betting may allow for secondary wagering functionality for these live events, which may be built into an EGM, ETG or betting terminal. The stream may be shown on the main display or a secondary display (e.g., top screen) of the EGM, or any other screens that are not being used for the machine's main game (such as an LCD button deck, player tracking screen, etc.).

In some examples, players watching the live stream may be=playing the same game as a player of a live primary game, but on other EGMs, with all of the players watching the live stream wagering the same amount as the first player, and with all players winning or losing the game as a group. In some examples, in a casino table game, e.g., poker, the cards that are dealt at the table may also be transmitted to remote players who see the same cards on a virtual poker table. In some examples, for each step of a live card game, the secondary players who are back-betting may bet on what decision the primary player will make when being dealt a card, play the game alongside the primary player, but making their own decisions (thereby creating their own poker hand), bet on what cards will be dealt next, bet on what kind of hand the primary players will get, and/or bet on which of the primary players will be in the most advantageous position, as desired. For a live roulette game, the secondary players who are back-betting can, for each spin, bet on a specific number, bet on the section or color where the ball will land, or if the number will be even/odd, bet on a sequence of specific numbers that will come up across multiple consecutive spins, and/or bet on a number of spins that will occur before one of the primary players wins a specific bet, as desired.

In some examples, historical poker matches could be used as the primary game instead of a live game. For famous televised previous games, new players may be recorded making the same moves, or new players may be animated with avatars. In some examples, random poker games from a casino may be selected and the electronic card shoes and cameras may collect game data for use in secondary games.

In some examples, the player of the primary game may receive a bonus or percentage based on the amount of back-bets wagered, based on total number of back betters, and/or based on number of viewers, etc. The bonus and/or percentage could come from the back bets, from the institution streaming, or the casino (e.g., casino's marketing budget). In some examples, a physical table game may be extended to an online location or to another casino location, e.g., via an ETG or mobile computing devices. In some examples, displays may be built into physical table game so the primary game players can play with and/or interact with remote players.

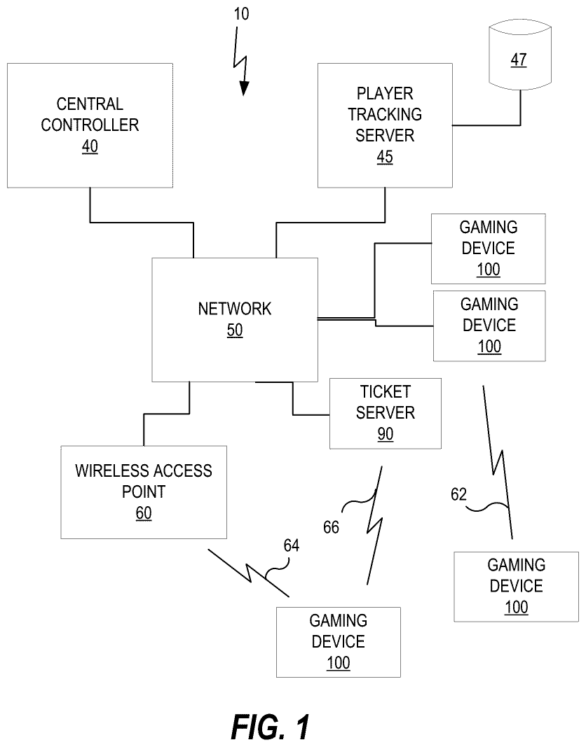

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

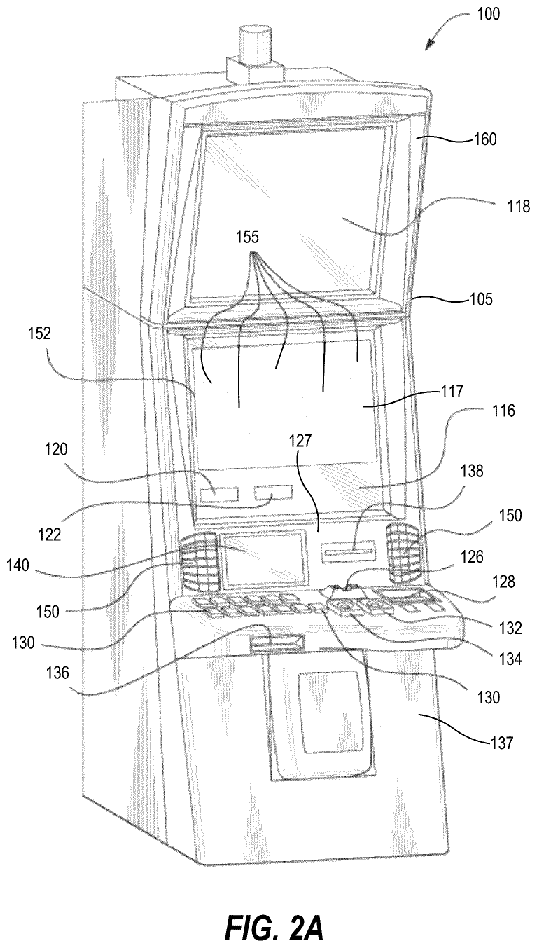

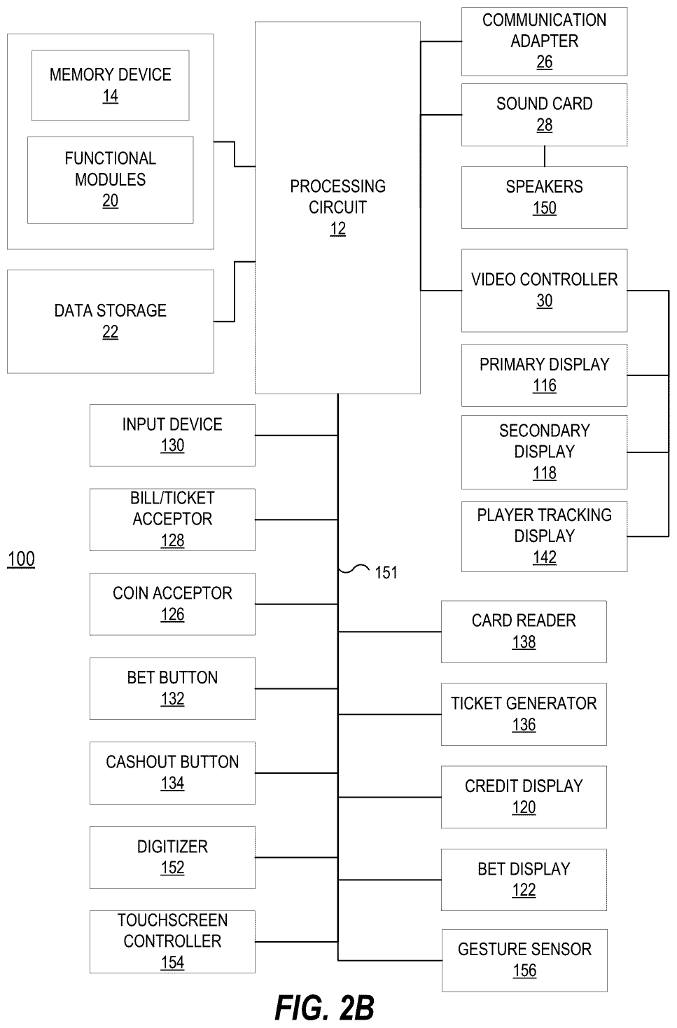

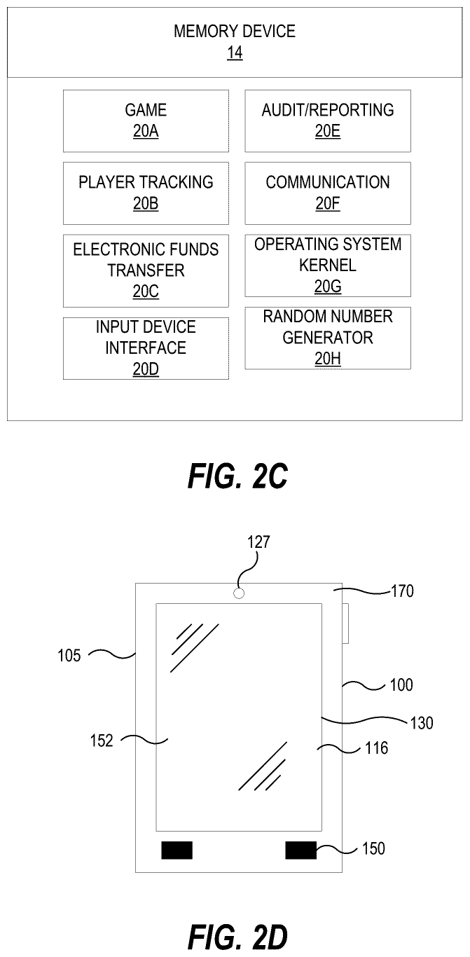

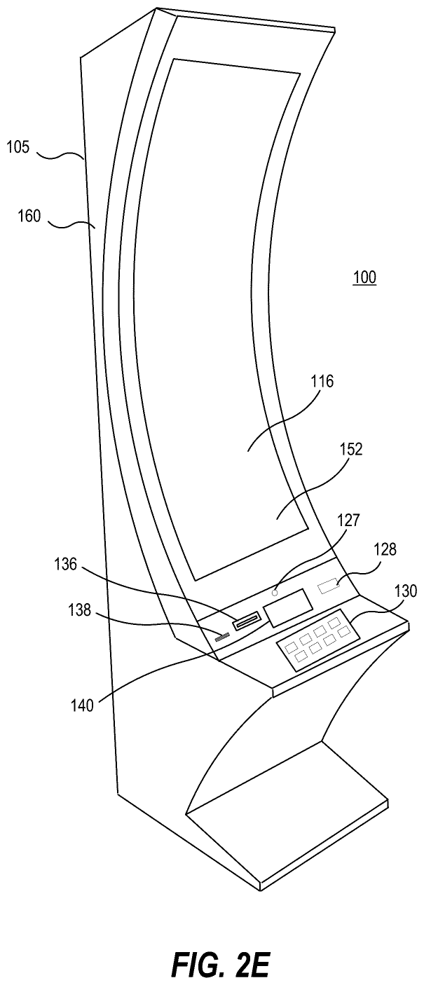

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

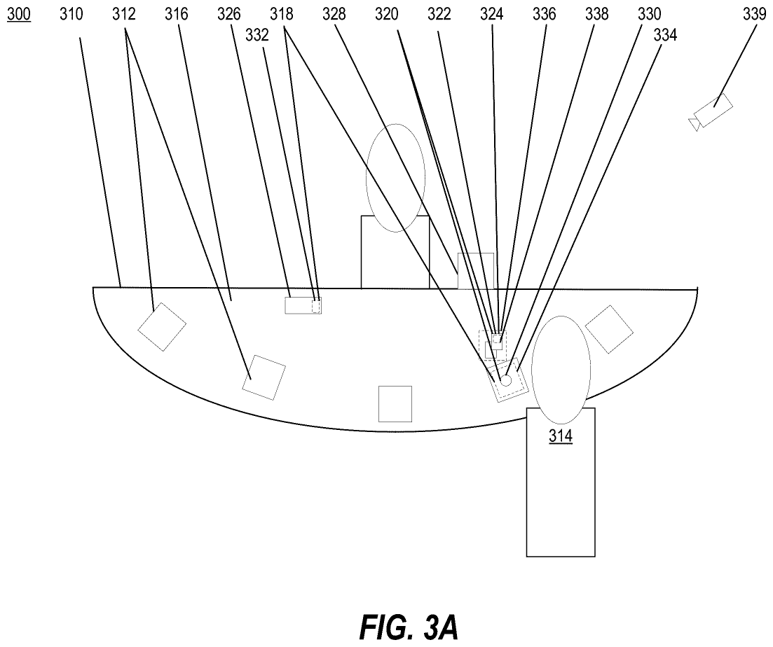

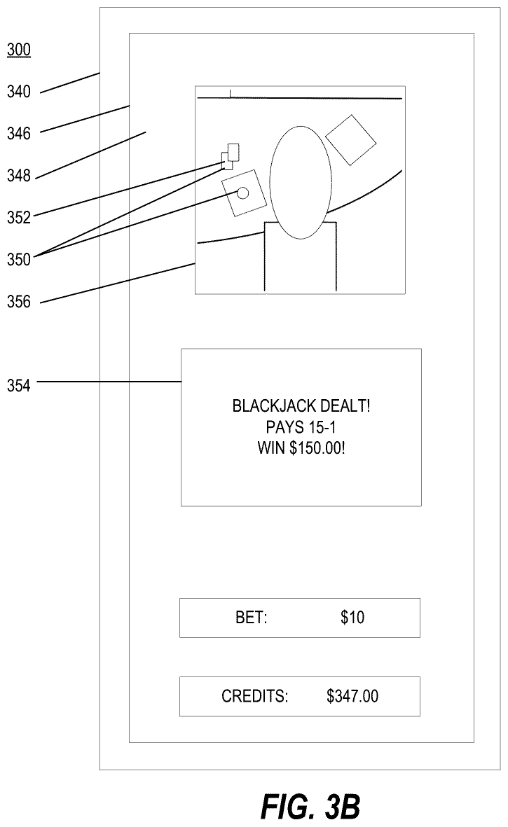

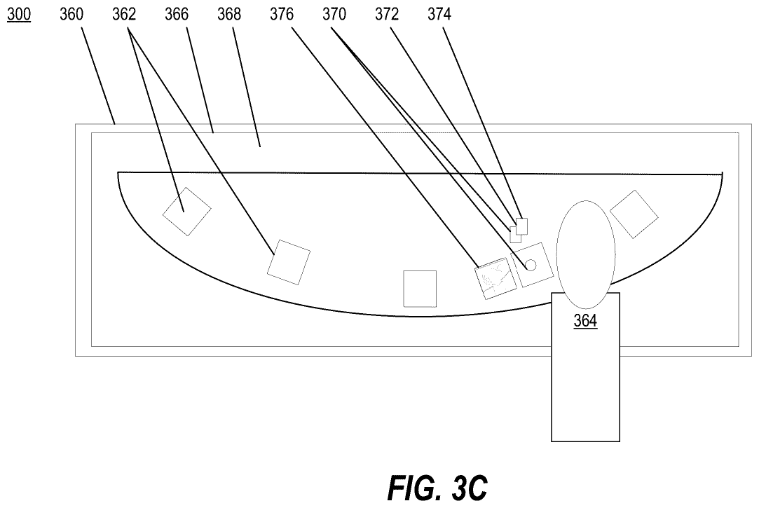

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

FIGS. 3A-3C illustrate a table game system 300 integrating a real world table 310 with a network-connected mobile device 340 and/or electronic table game device 360, according to some embodiments. As shown by FIG. 3A, the real world table 310, which is a blackjack table in this embodiment, in a casino environment may include a plurality of player positions 312, including for a first player 314, and a playing surface 316. A sensor device 318 detects and/or identifies parameter values real world objects 320, e.g., playing cards 322 and/or betting chips 330 in this embodiment, and the system 300 determines a first game result 324 based on the parameter values of the real world objects 320.

In some embodiments, the sensor device 318 may be integrated into the playing surface 316, a card shoe 326 and/or a card shuffler 328, etc., and may determine the presence and/or value of the game objects 320 via an image capture device 332 (e.g., a camera), a proximity sensor 334, and/or a radio frequency identification (RFID) transceiver 336 or other RF device. For example, in this embodiment, an image capture device 332 integrated into the card shoe 326 may identify individual card 322 values in response to drawing the card 322 from the shoe 326, which may allow the system 300 to determine the first game result 324 for the first player 314 and/or game results for other players at the other player positions 312. In another example, the system 300 may determine the values of one or more cards 322 as they are shuffled in the card shuffler 328. In some examples, the image capture device(s) 332 may derive the values of the cards 322 or other objects 320 from an image of the physical cards 322 or other objects 320 captured by the image capture device(s) 332. RFID transceivers 336 in the playing surface 316 may detect the presence and monetary of betting chips 330 in play, e.g., derived from data embedded in RFID tags 338 contained in the betting chips 330 and/or derived from a proximity of the betting chips 330 to a betting area 335 on the playing surface 316 detected by the proximity sensor 334, for example, and the system may determine and/or provide a game award for the first player 314 based on the first game result 324 and the determined value of the betting chips 330. In some examples, a video capture device 339 may capture video of gameplay at the real world table 310 may transmit the captured video to a game server for display by other computing devices.

Meanwhile, as shown by FIG. 3B, a second player may view play at the real world table 310 remotely via a mobile device 340, which may be in a casino or other environment, and which may be in communication with a game server of the system 300 via a network. The mobile device 340 may include a display 346 displaying a graphical user interface (GUI) 348 containing game object indications 350 corresponding to real world game objects 320, e.g., card indications 352 corresponding to playing cards 322, etc., at the physical table 310. Based on the game object indications 350, second player may place wagers, such as side bets or back bets, based on the wagering game being played by the first player 314 and/or game objects 320 indicated by the game object indications 350. The system 300 may determine as second game result 354 for the second player, and the system may determine and/or provide a game award for the second player based on the second game result 354 being a winning game result.

The GUI 348 may include a live video display 356 of the physical table 310 and game objects 320, e.g., as captured by the video capture device 339 for example, and/or the game object indications 350 may include animated or stylized representations of the real world game objects 320, as desired. In some examples, the video of the gameplay may be captured, transmitted, and/or displayed in near-real time, e.g., to facilitate live play at the table 310 for both the first player 314 and the second player. In some examples, the video of the gameplay may be pre-recorded before the second wager is received, e.g., in a past game session, so as to simulate simultaneous live play with the first player 314 and second player, even though the first player 314 and second player may be playing at different times.

As further shown by FIGS. 3C, the system 300 may also, or alternatively, include an ETG 360 in a different casino or other environment, for example, with a plurality of player positions 362 and a display surface 366 providing a GUI 368 including a plurality of game object indications 370 corresponding to the real world game objects 320, e.g., card indications 372 corresponding to physical playing cards 322 at the physical table 310. The system 300 may determine a third game result 374 for a third player 364 at the ETG 360 based on the wagering game being played by another player, e.g., the first player 314, and/or on game object indications 370 corresponding to the real world game objects 320, and the system may determine and/or provide a game award for the third player 364 based on the third game result 374 being a winning game result. Here again, the GUI 368 may include a live video display 376 of the physical table 310 and game objects 320, e.g., as captured by the video capture device 339 for example, and/or the game object indications 370 may include animated or stylized representations of the real world game objects 320, as desired.

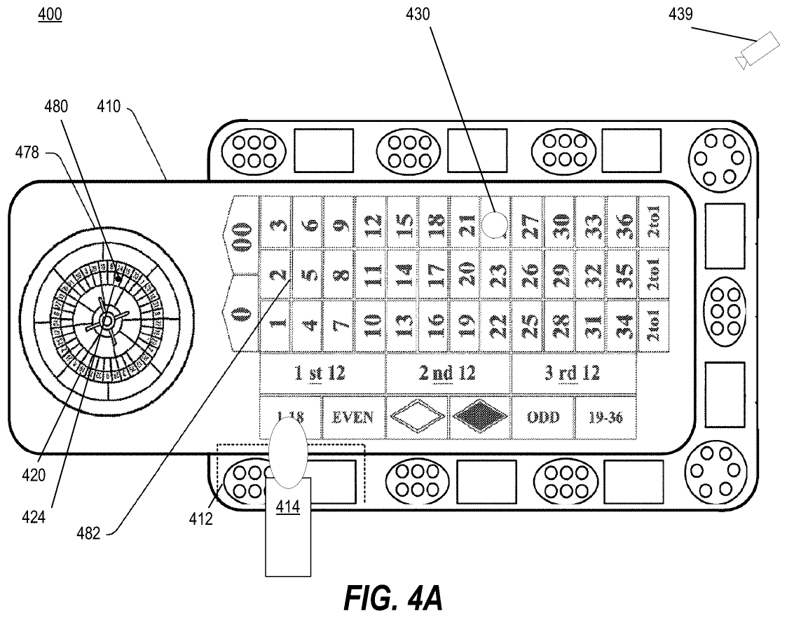

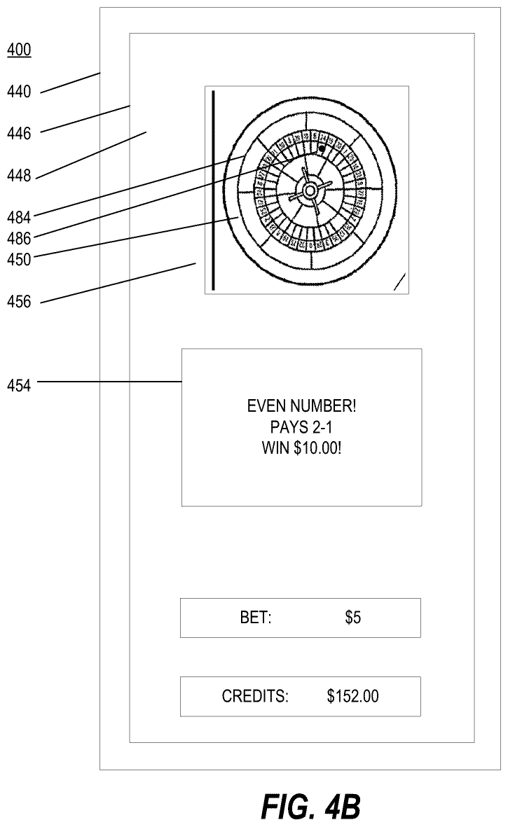

FIGS. 4A and 4B illustrate a table game system 400 integrating a real world table 410 and a network-connected mobile device 440, according to some embodiments. As shown by FIG. 4A, the real world table 410, which is a roulette table in this embodiment, in a casino environment may include a plurality of player positions 412, including for a first player 414, a physical and/or electronic roulette wheel 478 and a betting area 482. A sensor device 418 detects and/or identifies parameter values real world objects 420, e.g., a location of a roulette ball 480 in the wheel 478 and/or betting chips 430 in this embodiment, and the system 400 determines a first game result 424 based on the parameter values of the real world objects 420. For example, the sensor device 418 may be integrated into the roulette wheel 478 and/or ball 480, such that the system 400 may determine a physical rest position of the ball 480 within the wheel 478 and provide that information to other devices, such as the mobile device 440, for use by the system. In another example, a machine vision system analyzes still or video images of the roulette wheel 478 to determine the rest position of the ball 480 and the corresponding parameter value.

As shown by FIG. 4B, a second player may view play at the real world table 410 remotely via a mobile device 440, which may be in a casino or other environment, and which may be in communication with a game server of the system 400 via a network. The mobile device 440 may include a display 446 displaying a graphical user interface (GUI) 448 containing game object indications 450 corresponding to real world game objects 420, e.g., card indications 452 corresponding to the roulette wheel 478 and ball 480, etc., at the physical table 410. As with FIG. 3B, the GUI 448 of FIG. 4B may include a live video display 456 of the physical table 410 and game objects 420, e.g., as captured by a video capture device 439 at the real world table 410 for example, and/or the game object indications 450 may include animated or stylized representations of the real world game objects 420, e.g., a virtual wheel 484, virtual ball 480, etc., as desired.

Based on the game object indications 450, second player may place wagers, such as side bets or back bets, based on the wagering game being played by the first player 414 and/or game objects 420 indicated by the game object indications 450. The system 400 may determine as second game result 454 for the second player, and the system may determine and/or provide a game award for the second player based on the second game result 454 being a winning game result.

In this manner, any number of table games may be used for integrating a real world table and a network-connected mobile device, according to embodiments described herein. For example, a dice-base game, such as a craps table, may include sensors for detecting an upward facing face of a die or dice. For example, the sensor device may be integrated into the dice, such that the system may determine an upward facing face of each die and provide that information to other devices, such as the mobile device, for use by the system.

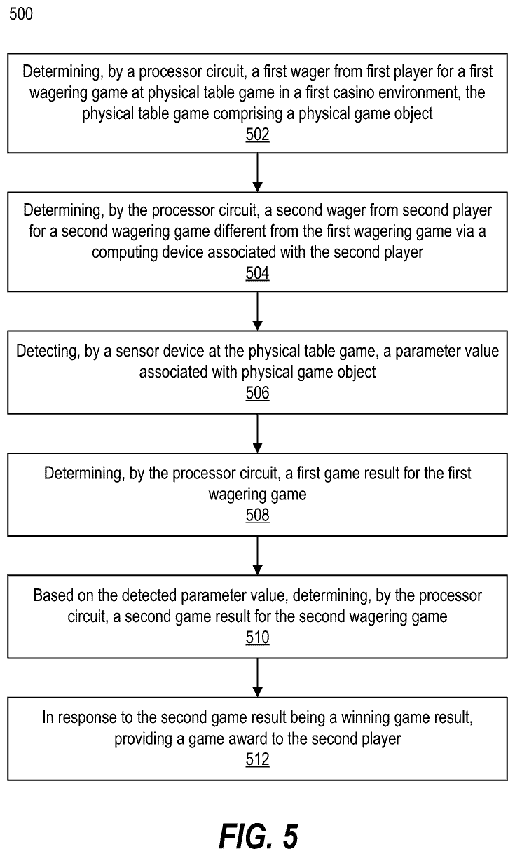

FIG. 5 is a flowchart illustrating operations 500 of systems/methods for facilitating embodiments described herein. The operations 500 may be performed by one or more processor circuits of one or more computing devices, such as any of the computing devices described herein, for example. The operations 500 may include determining, by a processor circuit, a first wager from a first player for a first wagering game at physical table game in a first casino environment, the physical table game comprising a physical game object (Block 502). The operations 500 may further include determining, by the processor circuit, a second wager from a second player for a second wagering game different from the first wagering game via a computing device associated with the second player (Block 504). The operations 500 may further include detecting, by a sensor device at the physical table game, a parameter value associated with physical game object (Block 506). The operations 500 may further include determining, by the processor circuit, a first game result for the first wagering game (Block 508). The operations 500 may further include, based on the detected parameter value, determining, by the processor circuit, a second game result for the second wagering game (Block 510). The operations 500 may further include, in response to the second game result being a winning game result, providing a game award to the second player (Block 512).

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory coupled to the processor circuit, the memory comprising machine-readable instructions that, when executed by the processor circuit, cause the processor circuit to:
determine a first wager from a first player for a first wagering game at physical table game in a first casino environment, the physical table game comprising a physical game object;
determine a second wager from a second player for a second wagering game different from the first wagering game via a computing device associated with the second player;
detect, by a sensor device at the physical table game, a parameter value associated with physical game object;
determine a first game result for the first wagering game;
based on the detected parameter value, determine a second game result for the second wagering game; and
in response to the second game result being a winning game result, provide a game award to the second player.

2. The system of claim 1, wherein the physical game object comprises a playing card, and wherein the parameter value comprises a card value for the playing card.

3. The system of claim 2, wherein the sensor device is part of a playing card shoe that, in response to drawing the playing card from the shoe, determines the card value for the playing card.

4. The system of claim 2, wherein the sensor device is part of a card shuffler device that, in response to shuffling a deck of playing cards, determines the card value for the playing card.

5. The system of claim 1, wherein the physical game object comprises a roulette ball, and wherein the parameter value comprises a rest position of the roulette ball in a physical roulette wheel of the physical table game.

6. The system of claim 1, wherein the physical game object comprises a die, and wherein the parameter value comprises an upward facing face of the die.

7. The system of claim 1, wherein the physical game object comprises a betting chip, and wherein the parameter value comprises a monetary value of the betting chip.

8. The system of claim 1, wherein the sensor device comprises an image capture device, and wherein the parameter value is derived from an image of the physical game object captured by the image capture device.

9. The system of claim 1, wherein the sensor device comprises a proximity sensor, and wherein the parameter value is derived from a detected proximity of the physical game object to the proximity sensor.

10. The system of claim 1, wherein the sensor device comprises radio frequency (RF) device, and wherein the parameter value is derived from an RF signal received from the physical game object.

11. The system of claim 10, wherein the physical game object comprises an RFID tag, and wherein the RF device comprises an RFID transceiver.

12. The system of claim 1, wherein the computing device comprises a mobile computing device associated with the second player in communication with a game server via a network.

13. The system of claim 1, wherein the computing device comprises an electronic table game (ETG) in another casino environment different from the first casino environment.

14. The system of claim 1, wherein the instructions further cause the processor circuit to:
capture, by a video capture device, video of gameplay of the first wagering game; and
transmit the video to the computing device for display by the computing device.

15. The system of claim 14, wherein the video of the gameplay is captured and transmitted in near-real time.

16. The system of claim 14, wherein the video of the gameplay is pre-recorded before the second wager is received.

17. A gaming device comprising:
a table game play area;
a sensor device;
a processor circuit; and
a memory coupled to the processor circuit, the memory comprising machine-readable instructions that, when executed by the processor circuit, cause the processor circuit to:
determine a first wager from a first player for a first wagering game at the gaming device in a first casino environment, the first wagering game comprising a physical game object;
determine a second wager from a second player for a second wagering game different from the first wagering game via a computing device associated with the second player;
detect, by the sensor device, a parameter value associated with physical game object;
determine a first game result for the first wagering game;
based on the detected parameter value, determine a second game result for the second wagering game; and
in response to the second game result being a winning game result, provide a game award to the second player.

18. The gaming device of claim 17, wherein the physical game object comprises a playing card,
wherein the parameter value comprises a card value for the playing card, and
wherein the sensor device is part of a card shuffler device that, in response to shuffling a deck of playing cards, determines the card value for the playing card.

19. A method comprising:
determining, by a processor circuit, a first wager from a first player for a first wagering game at physical table game in a first casino environment, the physical table game comprising a physical game object;
determining, by the processor circuit, a second wager from a second player for a second wagering game different from the first wagering game via a computing device associated with the second player;
detecting, by a sensor device at the physical table game, a parameter value associated with physical game object;
determining, by the processor circuit, a first game result for the first wagering game;
based on the detected parameter value, determining, by the processor circuit, a second game result for the second wagering game; and
in response to the second game result being a winning game result, providing a game award to the second player.

20. The method of claim 19, wherein the physical game object comprises a playing card, and wherein detecting the parameter value comprises detecting a card value for the playing card by the sensor device.
